(19) United States
(12) Patent Application Publication
(10) Pub. No.: US 2004/0238292 A1
(43) Pub. Date: Dec. 2, 2004

(54) Modular disc brake

(76) Inventors: Anders Ortegren, Landskrona (SE); Hakan P.O. Larsson, Billeberga (SE); Patrik Laursen, Paarp (SE); Kjell Onnestam, Eslov (SE)

Correspondence Address: ST. ONGE STEWARD JOHNSTON & REENS, LLC, 986 BEDFORD STREET, STAMFORD, CT, 06905-5619, US

(21) Appl. No.: 10/795,462

(22) Filed: Mar. 8, 2004

Related U.S. Application Data
(63) Continuation of application No. PCT/SE02/01518, filed on Aug. 26, 2002.

(30) Foreign Application Priority Data
Sep. 7, 2001 (SE) 0102989-1

(51) Int. Cl. F16D 55/00

(52) U.S. Cl. 188/71.1

(57) ABSTRACT

The present invention concerns a disc brake for vehicles, which disc brake comprises a box for receiving a brake mechanism and a caliper. The caliper is detachably fixed to the box. The disc brake is formed of different modules. The box could be said to be a mounting fixture for the other modules. By the modular form the disc brake consists of a number of smaller units facilitating handling during production, repair, maintenance etc.

This application is a continuation of pending International Patent Application No. PCT/SE02/01518 filed Aug. 26, 2002 which designates the United States and claims priority of pending Swedish Application No. 0102989-1 filed Sep. 7, 2001.

The present invention concerns a disc brake and more specifically a disc brake having a floating or sliding caliper. The brake has been developed for heavy duty vehicles, but a person skilled in the art realises that the brake of the present invention may be used for any type of vehicle.

As used in this description the expressions “rear” and “front” and expressions with similar meaning are in reference to a normal placing of the brakes. Thus, “front” refers to the side facing the wheel, while “rear” refers to the side facing the interior of the vehicle.

Disc brakes of the prior art are usually produced as large units, which leads to relatively heavy parts that may be cumbersome to produce. The production of the calipers of the prior art often involve machining in confined spaces for which specially designed tools may have to be used. In assembly the brake mechanism is often inserted into the caliper with a tight fit. This means that the brake mechanism has to be more or less turned and twisted to come into the designed space. However, as both the mechanism and the caliper are relatively heavy this will put a rather large stress on the assembling personnel. The large units have also drawbacks regarding maintenance and repair.

### SUMMARY OF THE INVENTION

According to the present invention the brake mechanism is placed in a box. The box could be regarded as a mounting fixture for the brake. The brake mechanism is received in a space of the box, which space is open towards one side of the box. Thus, the interior of the box may be machined using standard tools. Furthermore, it is relatively easy to mount the brake mechanism inside the box.

A caliper is rigidly and detachably fixed to the box to form the disc brake. The caliper is fixed to the box by means of suitable fastening means. The caliper may also be machined in a relatively simple fashion using standard tools. Preferably the caliper is of a design enabling it to be treated as a single unit both in assembly, transport, storage and the like. The caliper is received on a carrier fixed to the vehicle.

The box and caliper of the brake are guided on guiding pins to enable them to slide during braking, as is common for disc brakes having a floating or sliding caliper. In order to give accurate guidance and to relieve dynamic load to the caliper at least three guiding pins should be used. At least one guiding pin should be located on the outer side of the disc. Such a guiding arrangement will be advantageous regarding an even wear of the brake pads. During assembly the guiding pins are movable in a radial direction in respect of openings of the box.

Furthermore, at repair it is possible to let the caliper together with pads, pad springs, pad holders, wear indicator and guiding means be left sitting on the carrier fixed to the vehicle. The gliding means will get a connecting function between the carrier and the caliper in this case.

The brake of the present invention is formed of a number of separate units or modules that are put together in a simple way. A modular design has many advantages concerning production, service and aftermarket as well.

In production there are great advantages in the possibility to design the brake of several modules and thus have smaller units. There are casting advantages e.g. in the possibility to use a so-called automatic casting equipment giving economical advantages. The machining of smaller units is advantageously in that it will be easier to reach different surfaces and confined spaces. Smaller units give less weight per unit compared to a complete cast caliper and leads to a simplified handling in machining and in assembly. Smaller units/modules give advantages in service and aftermarket as a defect part or parts may be replaced without affecting the other modules of the brake. Smaller units makes it possible to decentralise mounting of the different modules giving logistic advantages in that the final assembly may be done in a controlled way e.g. by the end customer.

By using a brake formed of modules there are advantages in that the brake is relatively easy to adapt to the space available for a specific vehicle. Thus, it is possible to just modify the part that needs adaptation and it is not necessary to amend e.g. a complete caliper, which is both cost and time consuming. It is also possible to make the different parts of differing materials. One or several parts may e.g. be made of aluminium to save weight. The box and caliper may be cast but they may be produced in any suitable fashion.

To summarise the brake designed with a module form according to the present invention gives a flexible brake concerning production, type of material used, maintenance etc.

In view of the above one object of the present invention has been to form a brake that is relatively easy to produce, assemble, maintain, repair, store and transport.

This object is met by a disc brake for a vehicle comprising a box, which box receives the brake mechanism. A caliper is detachably fixed to the box. The brake is formed of different modules and the box is a mounting fixture for other modules.

Further objects and advantage with the present invention will be obvious for a person skilled in the art when reading the detailed description below of preferred embodiments.

### BRIEF DESCRIPTION OF THE DRAWINGS

The invention will be described more closely below by way of examples and with reference to the enclosed drawings. In the drawings

FIG. 1 is an exploded view of a first example of a brake according to the present invention,

FIG. 2 is an exploded view of the brake of FIG. 1 taken from the opposite direction,

FIG. 3 is a cross sectional view of a part of the brake of FIGS. 1 and 2,

FIG. 4 is a detail view taken from FIG. 3,

FIG. 5 is an exploded view of a second example of a brake according to the present invention,

FIG. 6 is a perspective view of the brake of FIG. 5 as assembled, and

FIG. 7 is a perspective and partly exploded view of a part of the brake of FIGS. 5 and 6.

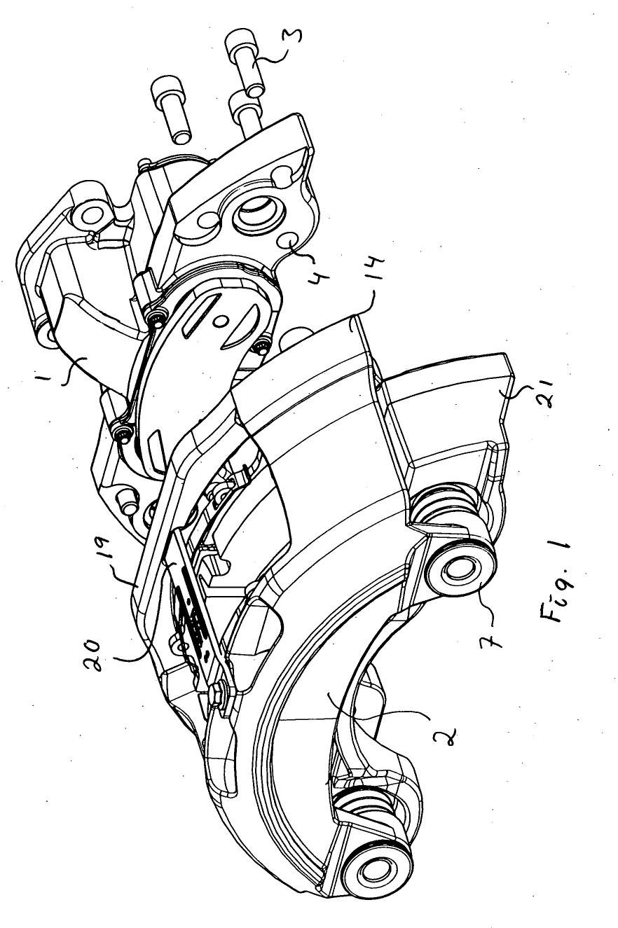

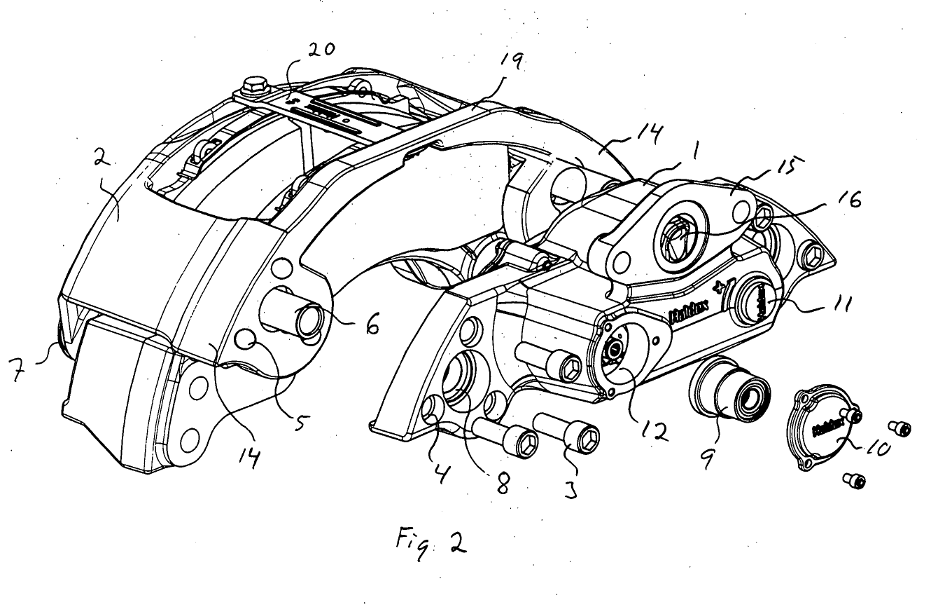

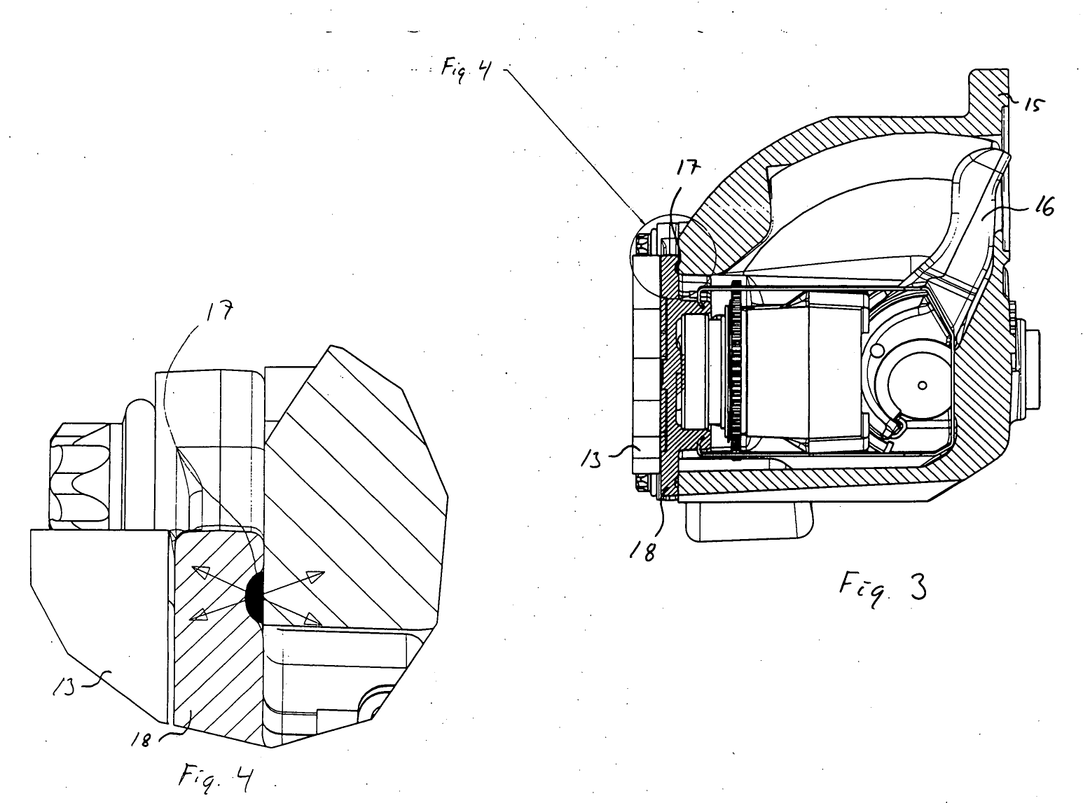

### DETAILED DESCRIPTION OF PREFERRED EMBODIMENTS

The brake according to a first example has a box 1, which is attached to a caliper 2 by means of a number of bolts 3. In the shown example there are six bolts 3, but a person skilled in the art realises that the number of bolts may vary depending on the available space, the expected forces etc. The box 1 could be referred to as a rear part while the caliper 2 is a front part. In practice the box 1 is a mounting fixture for other parts or modules of the brake.

The box 1 encloses the brake mechanism. The brake mechanism as such may have many different features, but as it forms no direct part of the present invention it will not be described extensively here. The box 1 has an attachment surface 15 to which a brake actuator (not shown) is connected either directly or indirectly. The brake actuator is e.g. a pneumatic cylinder. The brake actuator is to act on a lever 16 of the brake mechanism. The movement of the brake lever 16 will be transferred to plate 13 acting on pad holders or the like (not shown).

The brake mechanism is mounted as one unit in the box 1. The cover 18 of the mechanism is attached to the box 1 by means of fastening means. In the shown embodiment the fastening means are screws but a person skilled the art realises that any fastening means giving a secure attachment may be used. To protect the brake mechanism a seal 17 is arranged in the contact surface between the box 1 and the cover of the mechanism. The seal 17 is received in a well-defined groove placed either in the cover 18 or the box 1, or partly in both. The seal 17 is pre-tensioned in that the seal 17 is made of an elastic material and the outer dimensions of the seal 17 exceed the inner dimensions of the groove. Thus, as the cover 17 is securely attached to the box by means of the fastening means the seal 17 is compressed. During possible movement between the cover 18 and the box 1 at braking the seal 17 will expand and seal any gaps formed. The seal 17 hinders dirt and water from entering the interior of the box 1, harming the brake mechanism.

Without the compressed seal 17 dirt and water would penetrate into the interior, especially under heavy actuation of the brake and in use of a park brake. Furthermore, the brake mechanism is sealed between the cover and adjusting screws by means of bellows. The bellows are protected against heat and external influence by a protecting spring, which may be made of a stainless material.

Thus, after mounting of the brake mechanism in the box 1, the brake mechanism and box 1 will form a separate unit or module. In maintenance it is thus possible to replace the module with a new module to reduce the time the vehicle is at standstill. Then the brake mechanism of the old module may be repaired or maintained on location or sent to a specialist, such as the manufacturer.

The box 1 has through holes 4 for receiving the bolts 3 used to attach the caliper 2 to the box 1. Furthermore, the box 1 has through openings for receiving an adjustment means and a reset shaft. The through opening for the reset shaft is sealed with a radial seal preventing dirt and water from entering the compartment enclosing the brake mechanism. The reset shaft and adjustment means are standard parts of the brake mechanism and will not be described extensively here.

The adjustment means comprises a regulator 9. The regulator 9 is of great importance for the function of the brake. The regulator 9 may function mechanically, electrical, magnetically or a combination of these. The regulator 9 is received in an enlargement 12. The enlargement 12 may be reached from the rear of the box 1, which means that the regulator 9 may be replaced without disassemble of the brake.

To protect the brake mechanism from dirt, water and the like lids 10, 11 are placed covering the openings receiving the adjustment means and reset shaft, respectively. The lids 10, 11 are of an elastic or metallic material. In the shown embodiment the lid 10 covering the adjustment means is attached to the box by means of screws. Thus, if the regulator 9 is to be replaced the lid 10 is first taken away after loosening the screws and then the regulator 9 may be taken out and replaced with a new regulator 9. Then the lid 10 is once again attached to the box 1 by means of the screws.

The box 1 has also openings 8 for receiving guiding pins 6 placed at wings 14 of the caliper 2. The caliper 2 has two further guiding pins 7 received in a carrier 21. Thus, the caliper 2 is connected to the carrier 21 by means of the two further guiding pins 7. The function of the guiding pins 6, 7 is to enable the caliper 2 together with the box 1 to be slid during braking, as is well known in the prior art. During mounting of the caliper 2 on the box 1 the guiding pins 6 may move radially in relation to the holes 8 of the box 1.

According to the present invention three or more guiding pins 6, 7 should be used. In the shown embodiment four guiding pins 6, 7 are used. Designs having three or more guiding pins 6, 7 have proved to give a stiffness and is relieving with respect to the caliper. The relieving effect is mainly for the bolts 3 but also for the other parts of the brake, which will be under heavy stress when the brake is actuated. The design will give a continuous flow of force from the counter part of the outer brake pad on the caliper 2, through the carrier, further to the inner guiding pins 6 connected to the box 1. Due to the at least three guiding pins 6, 7 the brake will have advantages regarding accurate guiding of the caliper, which will give an even wear of the brake pads.

The guiding pins 6, 7 may be made of non-corrosive material in order to prevent that they will stick by rust, especially during extended periods of stationary or less use of the brake, which may give rise to poor brake action and that the pads wear unevenly.

The caliper 2 is to encircle one or more brake discs and brake pads (not shown) in the normal way. The caliper 2 has a main or front part on the side opposite the box 1. Two wings 14 extend from the main part of the caliper 2 directed towards the box 1. A bridging part 19 goes between the wings 14 of the caliper. An opening is formed in the caliper 2 by the main part, the wings 14 and the bridging part 19. A strut 20 is detachably secured to the caliper 2. The strut 20 will go over the opening of the caliper 2 and support the brake pad holders (not shown) in braking. Furthermore, if the strut 20 is removed it may be possible to replace worn out brake pads by simply lifting up them through the opening of the caliper 2. The caliper 2 has threaded openings 5 for receiving the bolts 3 used to securely attach the caliper 2 to the box 1.

The caliper 2 is to be placed on a carrier 21 fixed in normal way to the vehicle. The caliper 2 will slid on the carrier 21 during braking. The carrier 21 forms one further unit or module. In maintenance, repair or the like it is possible to let the module or unit formed by the caliper 2, together with pads, pad springs, pad holders, wear indicator and guiding means be left sitting on the carrier 21, while the module formed by the box 1 is taken out by unscrewing the bolts 3.

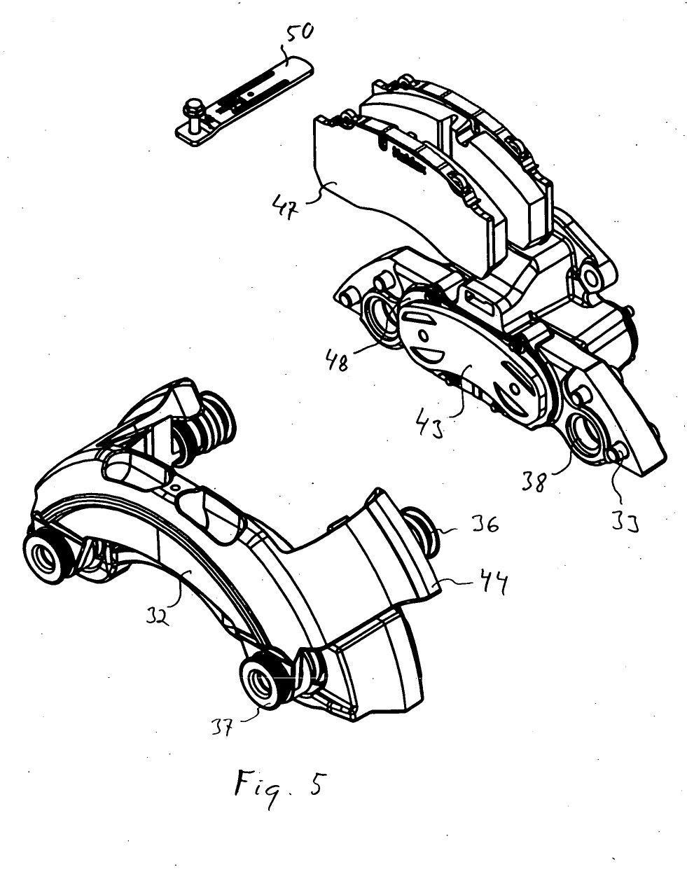

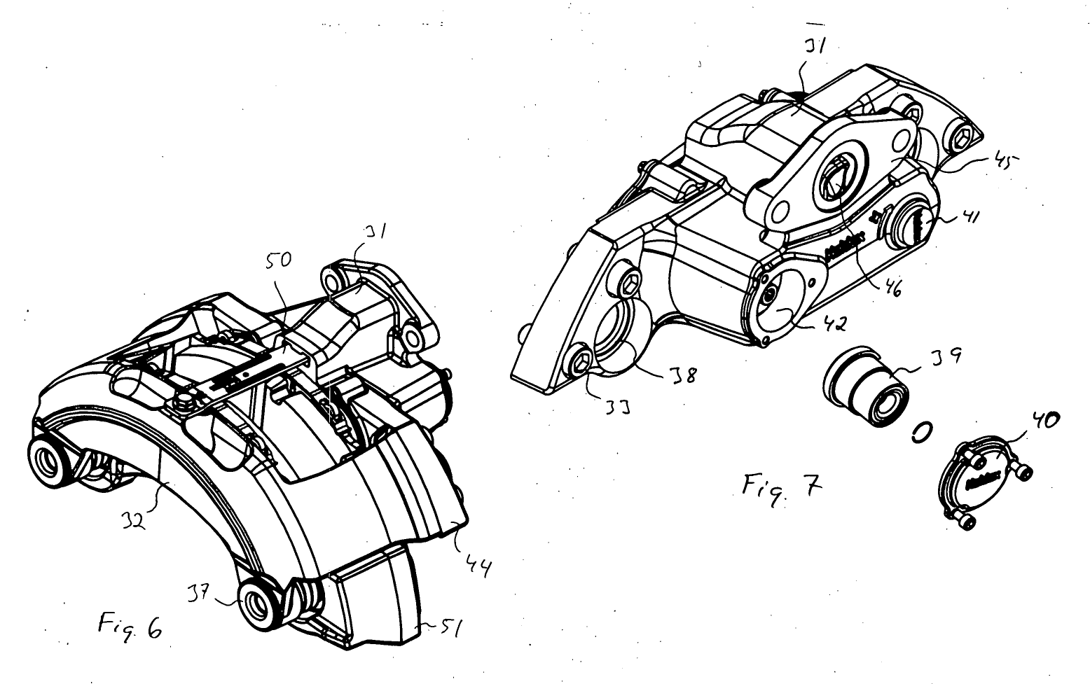

A second example of the present invention is shown in FIGS. 5 to 7. Also in this example a caliper 32 is attached to a box 31 by means of bolts 33, in this case three bolts 33. The brake of the second example is identical with the brake of the first example in many respects and the identical parts will not be described extensively once again.

The box 31 receives the brake mechanism in a space open towards the front side of the box 31. As for the first example a brake actuator is to be connected directly or indirectly to the brake mechanism at an attachment surface 45. The brake actuator is to act on a lever 46 of the brake mechanism. The movement of the brake lever 46 will be transferred by the mechanism, to a plate 43 acting on brake pad holders 47 or the like.

The brake mechanism is mounted as one unit in the box 31. The cover 48 of the brake mechanism is attached to the box 31 by means of fastening means. In the same way as stated in the above example a compressed seal is placed in a well-defined groove, formed in the cover 38 and/or the box 31.

Also the box 31 of this second example has a number of through holes or openings for receiving bolts 33, guiding pins 36, adjusting means and a reset shaft, respectively. The regulator 39 of the adjusting means is received in an enlargement 42 on the rear side of the box 31. To protect the brake mechanism lids 40, 41 are furnished for covering the ends of the holes receiving the adjustment means and the reset shaft, respectively.

The box 31 has holes 38 for receiving two guiding pins 36 on the caliper 32. Two further guiding pins 37 are attached to the opposite side of the caliper 32 for co-operation with a carrier 51. As stated above the function of the guiding pins 36, 37 is to enable the caliper 32 to slid together with the box 31 during braking. The caliper 32 will slid on the carrier 51. In order to have an accurate guiding at least three guiding pins 36, 37 should be arranged. At least one of said guiding pins 37 should be located on the outer side of the disc. During assembly the guiding pins 36 are movable in a radial direction in respect of the openings 38 of the box 31.

At assembly one end of a strut 50 is inserted in an opening in the box 31, while then other end of the strut 50 is attached to the caliper 32 by any suitable fastening means. The function of the strut 50 is to assist in keeping the brake pad holders 47 in place during braking.

The caliper 32 has a main or front part and wings 44 extended towards the box 31. The box 31 is fixed to the ends of the wings 44. The caliper 32 of this example has no bridging part. An opening resembling the opening of the caliper 2 of the first example is formed by the main part of the caliper 32, the wings 44 and the front side of the box 31.

What is claimed is:

1. A disc brake for a vehicle, comprising a box (1, 31) for receiving a brake mechanism and a caliper (2, 32) detachably fixed to the box (1, 31), characterized in that the brake is formed of different modules, that the box (1, 31) is a mounting fixture for other modules and that one module is formed by a caliper (2, 32) together with at least three guiding pins (6, 7, 36, 37).

2. The disc brake of claim 1, characterized in that one module is formed by the box (1, 31) receiving the brake mechanism, which brake mechanism is received as a single unit in the box (1, 31).

3. The disc brake of claim 1 or 2, characterized in, that the module formed by the caliper (2, 32) and at least three guiding pins (6, 7, 36, 37) also includes brake pad holders (47) and possible wear indicators.

4. The disc brake of claim 3, characterized in that one module is formed by a carrier (21, 51) fixed to the vehicle, the caliper (2, 32) rests on the carrier (21, 51) and is connected to the carier (21, 51) by at least two guiding pins (7, 37).

5. The disc brake of any of the previous claims, characterized in that the caliper (2, 32) is fixed to the box (1, 31) by means of fastening means (3, 33) and that the box (1, 31) has through holes (4) for receiving the fastening means (3, 33).

6. The disc brake of any of the previous claims, characterized in that a cover (18, 48) of the brake mechanism is securely fixed to the box (1, 31) and that a seal (17) is received and compressed during assembly in a groove in the cover (18, 48) and/or the box (1, 31).

7. The disc brake of any of the previous claims, characterized in that at least one of the guiding pins (6, 36) is received in an opening (8, 38) of the box (1, 31) and that the at least one guiding pin (6, 36) may move in a radial direction in respect of the opening (8, 38) of the box (1, 31) during assembly.

8. The disc brake of any of the previous claims, characterized in that an adjustment means and a reset shaft are received in through openings of the box (1, 31), that the ends of the openings are covered by lids (10, 11, 40, 41) and that a regulator (9, 39) of the adjustment means is received in an enlargement (12, 42) on the side of the box (1, 31) intended to be facing the interior of the vehicle.

9. The disc brake of claim 8, characterized in that the regulator (9, 39) may be inserted and taken out from the outside and in that the regulator (9, 39) is mechanical, electrical, magnetic or a combination of these.

10. The disc brake of claim 8, characterized in that the two lids (10, 11, 40, 41) are made of an elastic material or a metal.

11. The disc brake of any of the claims 3 to 10, characterized in that the guiding pins (6, 7, 36, 37) are made of a non-corrosive material.

12. The disc brake of any of the claims 8 to 11, characterized in that a radial seal is placed in the opening receiving the reset shaft.

13. The disc brake of any of the previous claims, characterized in that the caliper (2, 32) has two wings (14, 44) extending from a front part of the caliper (2, 32) towards the box (1, 31) and that the outer ends of the wings (14, 44) will abut the box (1, 31) after assembly.

14. The disc brake of claim 13, characterized in that threaded openings (5) are furnished at the end surface of each wing (4, 44) to receive the fastening means (3, 33) used for fixing the caliper (2, 32) to the box (1, 31).

15. The disc brake of claim 13 or 14, characterized in that a bridging part (19) is arranged between the ends of the wings (4) of the caliper (2).

16. The disc brake of claim 15, characterized in that a strut (20) is detachably secured between the bridging part (19) and a main part of the caliper (2), which strut (20) cross an opening formed in the caliper.

17. The disc brake of any of the claims 1 to 14, characterized in that a strut (50) is detachably secured to the box (31) and a main part of the caliper (32), which strut (50) cross an opening formed in the caliper (32).

18. The disc brake of any of the previous claims, characterized in that one or several parts are made of aluminium.
